(19) United States
(12) Patent Application Publication
(10) Pub. No.: US 2012/0316908 A1
(43) Pub. Date: Dec. 13, 2012

(54) APPARATUS AND METHOD FOR MANAGING NEW PRODUCT AND TECHNOLOGY INTRODUCTION BASED ON WORK PROCESS

(76) Inventors: Sung-bum Park, Cheongju-si (KR); Sang-ho Park, Cheongju-si (KR); Jun-pyo Kim, Cheongju-si (KR); Sun-woong Woo, Cheongju-si (KR)

(21) Appl. No.: 13/488,950

(22) Filed: Jun. 5, 2012

(30) Foreign Application Priority Data
Jun. 8, 2011 (KR) 10-2011-0054878

(51) Int. Cl. G06Q 10/06

(52) U.S. Cl. 705/7.15

(57) ABSTRACT

An apparatus and a method for managing a new product and technology introduction based on a work process, are provided. The apparatus includes a display unit configured to display each stage of a project. The apparatus further includes an input unit configured to receive generation request information of a job item in each stage and progress result information indicating completion of the job item in each stage. The apparatus further includes a controller configured to control the display unit to display each stage of the project based on the generation request information and/or the progress result information.

### CROSS-REFERENCE TO RELATED APPLICATION

This application claims the benefit under 35 U.S.C. §119(a) of Korean Patent Application No. 10-2011-0054878, filed on Jun. 8, 2011, in the Korean Intellectual Property Office, the entire disclosure of which is incorporated herein by reference for all purposes.

### BACKGROUND

1. Field

The following description relates to an apparatus and a method for managing a new product and technology introduction based on a work process.

2. Description of Related Art

A project management system (PMS) is a program that is developed for a general purpose, that manages a large-scale project, and that performs network management, cost management, resource allocation management, and report processing for each job. However, the PMS is not appropriate for a semiconductor development process requiring identification of a development process at a glance, speedy decision-making, and close cooperation. Also, in the PMS, there is a gap between project management and an actual work process, which limits an effectiveness of the project management. Further, since the PMS has a relatively complicated authority system and makes effective communication with a relevant department difficult, horizontal communications may not be established among persons in charge to proceed with a project and vertical decision-making may not be achieved. Thus, there may be a delay in meeting a development schedule.

### SUMMARY

In one general aspect, there is provided an apparatus configured to manage a new product and technology introduction based on a work process, including a display unit configured to display each stage of a project. The apparatus further includes an input unit configured to receive generation request information of a job item in each stage and progress result information indicating completion of the job item in each stage. The apparatus further includes a controller configured to control the display unit to display each stage of the project based on the generation request information and/or the progress result information.

The controller includes a job item generation unit configured to generate the job item in each stage based on the generation request information. The controller further includes a task generation unit configured to generate a task associated with the job item in each stage based on the generation request information.

The generation request information includes job performance period information of the job item and the task in each stage. The controller further includes a job period display unit configured to display the job performance period information based on the generation request information.

The controller further includes a task management unit configured to display a color of a current task in a current stage of the project based on the progress result information. The controller further includes a job item approval unit configured to determine whether to progress to a next job item in a next stage of the project based on the color of the current task, and determine whether to change the color of the current task that has been completed based on the determination of whether to progress to the next job item. The controller further includes a job item management unit configured to display colors of a current job item in the current stage and the next job item based on the determinations of the job item approval unit. The task management unit is further configured to display a color of a next task in the next stage based on the determinations of the job item approval unit.

The task management unit is further configured to display the color of the current task based on job performance period information of the current task.

The job item management unit is further configured to compare job performance period information of the current job item with job completion period information generated if the current job is completed. The job item management unit is further configured to display a portion of the current job item in a color different from that of the current job item.

The controller further includes a result informing unit configured to transmit a processing result guide message to a mail or a mobile terminal of a person in charge of the next stage based on the displaying of the task management unit or the determinations of the job item approval unit.

The apparatus further includes a project DB configured to store performance result information indicating completion of a task in each stage of projects. The controller further includes a task material reading unit configured to provide the performance result information from the project DB based on a request of a user.

The project DB is further configured to store job performance period information of a job item in each stage of the projects, and job completion period information generated if the job item in each stage of the projects is completed. The controller further includes a project progress providing unit configured to compare the job performance period information with the job completion period information, and provide a progress of the project.

The controller further includes a situation statistic unit configured to provide information of situations of the projects or information of a situation of the job item in each stage of the project based on the job performance period information and the job completion period information.

The project is a semiconductor technology introduction project and/or a semiconductor new product project.

In another general aspect, there is provided a method of managing a new product and technology introduction based on a work process, including displaying a current job item among job items performed in a project, and/or a current task associated with the current job item, as being in progress. The method further includes determining whether the current job item is finished based on whether the current task is completed. The method further includes displaying a next job item among the job items, and/or a next task associated with the next job item, as being in progress if the current job item is finished.

The displaying of the current job item and/or the current task includes receiving job performance period information of the current job item and/or the current task. The displaying of the current job item and/or the current task further includes determining whether a job state of the current job item is normal based on job performance period information of the current job item. The displaying of the current job item and/or the current task further includes displaying the current job item and the current task in a color based on whether the job state is normal.

The determining of whether the job state is normal includes determining whether the current job item and the current task are being performed within the job performance period information.

The determining of whether the current job item is finished includes determining whether progress result information indicating completion of the current task is input. The determining of whether the current job item is finished further includes displaying the current task in a color indicating the completion of the current task if the progress result information is input. The determining of whether the current job item is finished further includes determining whether the current task is completed based on whether the current task is in the color indicating the completion of the current task.

The determining of whether the current job item is finished further includes displaying the current job item in a color indicating completion of the current job if the current task is in the color indicating the completion of the current task.

The determining of whether the current job item is finished further includes displaying the current task in a color indicating a job progress state of the current task based on the job performance period information of the current task if the progress result information is not input.

The displaying of the current task in the color indicating the job progress state includes displaying the current task in a color indicating a normal job progress state of the current task if the current task is being performed within the job performance period information. The displaying of the current task in the color indicating the job progress state further includes displaying the current task in a color indicating an abnormal job progress state of the current task if the current task is being performed beyond the job performance period information.

The project is a semiconductor technology introduction project and/or a semiconductor new product project.

A computer-readable storage medium stores a program including instructions to cause a computer to perform the method.

Other features and aspects may be apparent from the following detailed description, the drawings, and the claims.

### BRIEF DESCRIPTION OF THE DRAWINGS

FIG. 1 is a block diagram illustrating an example of an apparatus configured to manage a new product and technology introduction based on a work process.

FIG. 2 is a diagram illustrating an example of a work process of a technology introduction-related project.

FIG. 3 is a diagram illustrating an example of a work process of a new product development-related project.

FIG. 4 is a flowchart illustrating an example of a method of managing a new product and technology introduction based on a work process.

FIG. 5 is a flowchart illustrating an example of a method of displaying a job progress state of a job item in each stage of a project and/or at least one task associated with the job item in an apparatus configured to manage a new product and technology introduction based on a work process.

FIG. 6 is a flowchart illustrating an example of a method of determining whether to finish a job item displayed as being in progress in an apparatus configured to manage a new product and technology introduction based on a work process.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

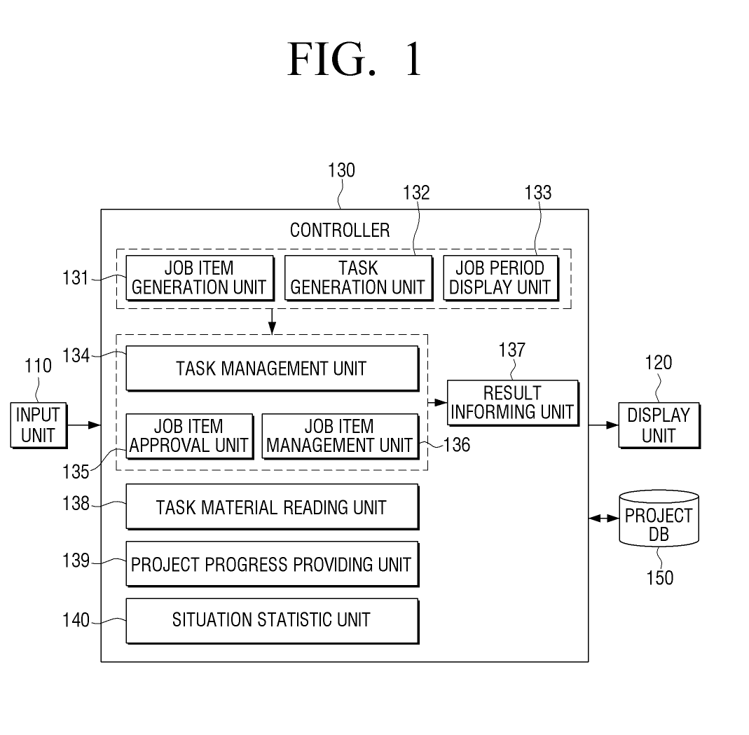

FIG. 1 is a block diagram illustrating an example of an apparatus configured to manage a new product and technology introduction based on a work process. The apparatus includes an input unit 110, a display unit 120, and a controller 130. The input unit 110 receives generation request information of a job item in each stage of a technology introduction-related or new product-related project, and progress result information of the job item in each stage. For example, the generation request information includes information on the job item performed in each stage of the project and/or information on tasks of each job item. Also, the generation request information includes, for example, information on job performance periods (e.g., expected completion dates) of the job item in each stage and the tasks of each job item. In another example, the progress result information may indicate completion of the job item and/or the associated tasks in each stage. The display unit 120 displays a progress of each stage of the project on a screen based on a control command of the controller 130. The controller 130 controls the display unit 120 to display the progress of each stage of the project based on the information input from the input unit 110.

To perform the controlling of the display unit 120, the controller 130 includes a job item generation unit 131, a task generation unit 132, a job period display unit 133, a task management unit 134, a job item approval unit 135, and a job item management unit 136. The job item generation unit 131 generates a job item to be performed in each stage of the project based on the generation request information input from the input unit 110. The task generation unit 132 generates tasks associated with each job item based on the generation request information. The job period display unit 133 displays the job performance period information of the job item generated by the job item generation unit 131 with reference to the job performance period information of the job item in each stage that is included in the generation request information.

The task management unit 134 displays and/or adjusts a color of each task based on the progress result information of the associated job item that is input from the input unit 110. The job item approval unit 135 determines whether to progress to a next job item based on the color of each task, and determines whether to change the color of the completed tasks based on the determination of whether to progress to the next job item. The job item management unit 136 displays and/or adjusts colors of the job item and the next job item, based on the determinations of the job item approval unit 135. The task management unit 134 displays and/or adjusts colors of tasks associated with the next job item, based on the determinations of the job item approval unit 135.

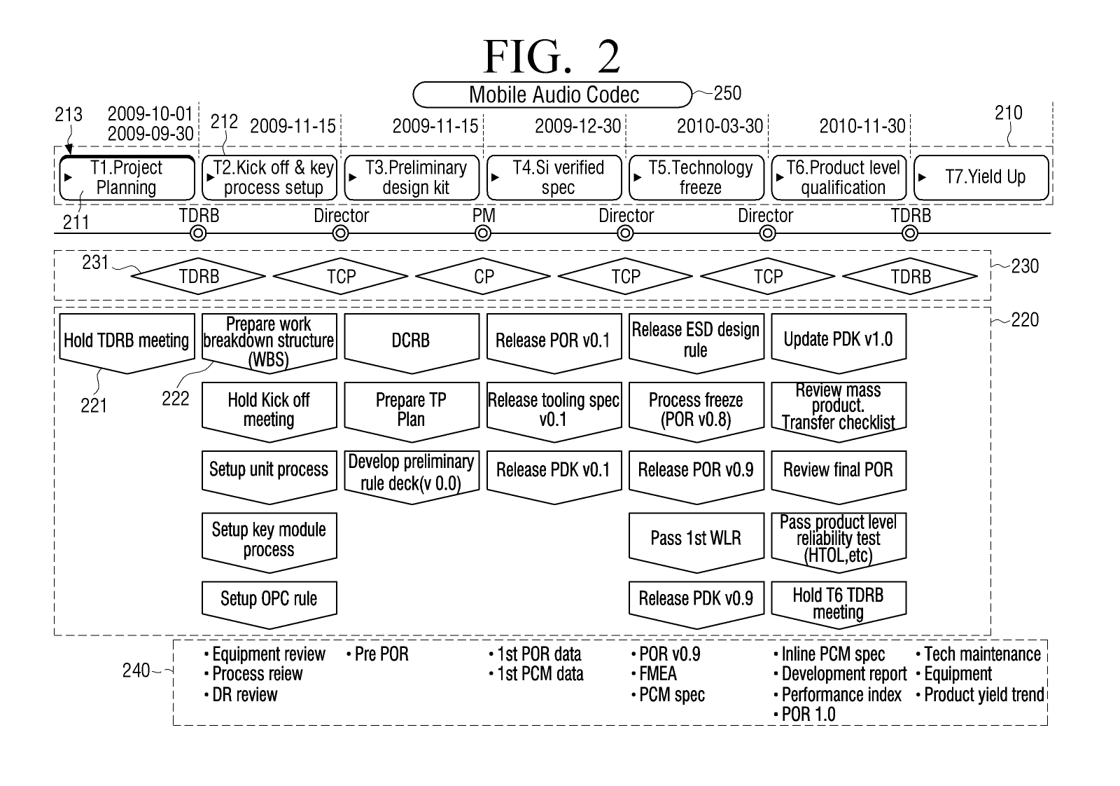

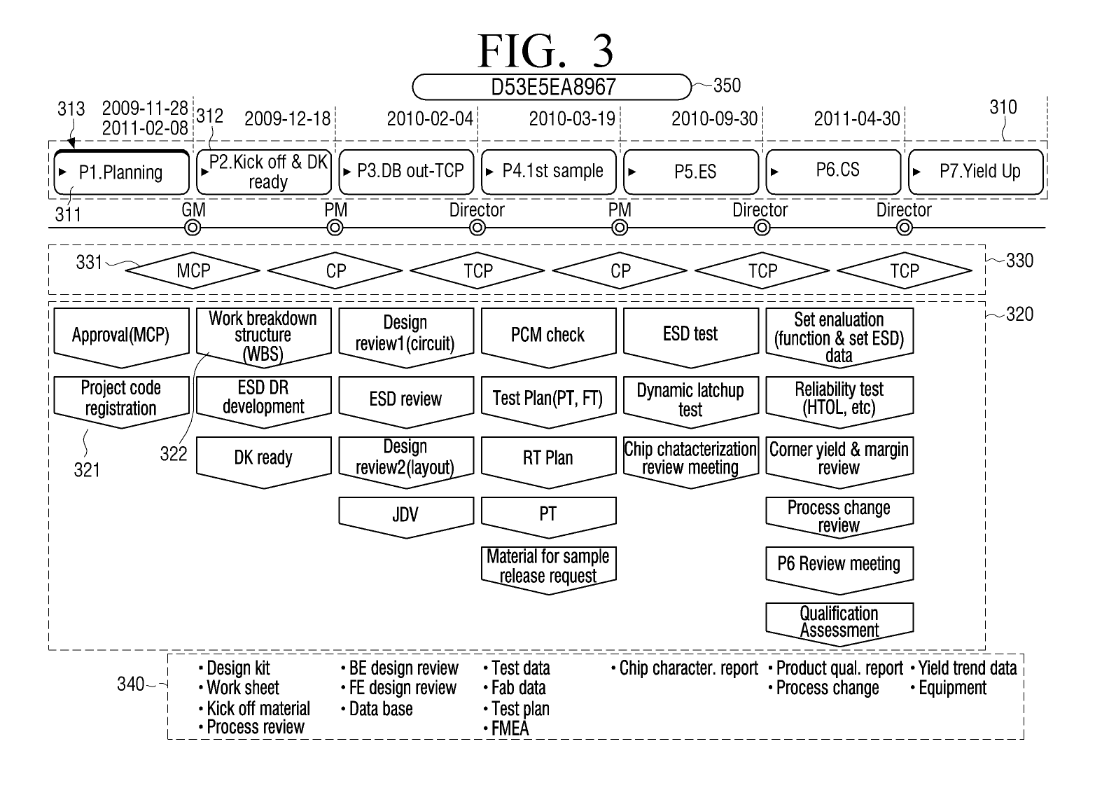

FIG. 2 is a diagram illustrating an example of a work process of a technology introduction-related project. FIG. 3 is a diagram illustrating an example of a work process of a new product development-related project.

In examples, a user may request generation of a job item in each stage of a project based on a characteristic of the project, as shown in FIG. 2 or 3. According to the user's request, the apparatus of FIG. 1 may establish a work process for a semiconductor technology introduction-related project, as shown in FIG. 2, or may establish a work process for a semiconductor new product development-related project, as shown in FIG. 3. As shown in FIG. 1, the apparatus generates a job item of each stage and tasks of each job item through the job item generation unit 131 and the task generation unit 132. As shown in FIG. 2 or 3, the job item of each stage is displayed in a job item section 210 or 310, and the tasks associated with each job item is displayed in a task section 220 or 320.

With reference to FIG. 1, the task management unit 134 displays the color of each task based on the progress result information input from the input unit 110. For example, with reference to FIG. 2 or 3, a task 221 or 321 is displayed in a blue color if progress result information associated with the task 221 or 321 is input. That is, if the progress result information indicating completion of the task 221 or 321 is input, the task 221 or 321 is displayed in the blue color indicating the completion of the task 221 or 321.

Referring to FIG. 2 or 3, if all tasks associated with a job item 211 or 311 are displayed in the blue color, a person in charge of the job item 211 or 311 checks states (e.g., completion) of the tasks associated with the job item 211 or 311, and determines whether to progress to a next stage. That is, if the person in charge inputs approval request information for a next job item 212 or 312 when all of the tasks associated with the job item 211 or 311 are completed, the job item approval unit 135 (of FIG. 1) displays an approval item 231 or 331 in the blue color to progress to the next job item 212 or 312. The approval item 231 or 331 is among approval items displayed in an approval item section 230 or 330, respectively, for approval in each stage. However, the approval item and the color listed above are merely examples, and other items and colors may be used depending on the situation. If the person in charge inputs rejection information for the next job item 212 or 312, the job item approval unit 135 displays the completed job item 211 or 311 and the tasks associated with the job item in a color indicating that the person in charge rejects progress to the next job item 212 or 312 based on the rejection information.

If the approval item 231 or 331 is displayed in the blue color, the job item management unit 136 (of FIG. 1) displays the completed job item 211 or 311 in the blue color indicating the completion of the job item 211 or 311. The job item management unit 136 compares the job performance period information of the completed job item 211 or 311, with job completion period information generated at a time when the job item 211 or 311 is completed, e.g., when a color of the job item 211 or 311 is differently-displayed. Based on this comparison, the job item management unit 136 displays a portion 213 or 313 of the job item 211 or 311 in a color different from that of the blue color of the job item 211 or 311. The job performance period information of each job item is displayed in an upper portion of the job item section 210 or 310, and the job completion period information regarding completion of each job item is displayed under the job performance period information. Accordingly, if the job item approval unit 135 determines to progress to the next job item 212 or 312, the job item management unit 136 compares the job completion period information of the job item 211 or 311 that is generated based on the determination, with the job performance period information of the completed job item 211 or 311, and displays the portion 213 or 313 of the completed job item 211 or 311 in a different color based on the comparison.

For example, as shown in FIG. 2, if the job performance period information of the job item 211 is 2009 Oct. 1 and the job completion period information of the job item 211 is 2009 Sep. 30, the job item management unit 136 determines that the job item 211 has been completed within a job performance period, and displays the upper portion 213 of the job item 211 in a green color. Accordingly, the upper portion 213 of the job item 211 is displayed in the green color, and a remaining portion of the job item 211 is displayed in the blue color so that the person in charge may identify that the job item 211 has been completed within the job performance period.

In another example, as shown in FIG. 3, if the job performance period information of the job item 311 is 2009 Nov. 28 and the job completion period information of the job item 311 is 2011 Feb. 8, the job item management unit 136 determines that the job item 311 has not been completed within the job performance period, and displays the upper portion 313 of the job item 311 in a red color. However, the information and the colors listed above are merely examples, and other information and colors may be used depending on the situation. The job item management unit 136 may display the upper portion 313 of the job item 311 in a color indicating a normal state (for example, blue) or in a color indicating an abnormal state (for example, red) based on whether a period indicated by the job completion period information exceeds the period indicated by the job performance period information by an amount greater than a predetermined threshold. Accordingly, the upper portion 313 of the job item 311 is displayed in the red color and a remaining is displayed in the blue color so that the person in charge may identify that the job item 311 has been completed beyond the job performance period.

Referring to FIG. 2 or 3, if it is determined to progress to the next job item 212 or 312, the job item management unit 136 (of FIG. 1) displays the job item 211 or 311 in a color indicating the completion of the job item 211 or 311, and simultaneously displays the next job item 212 or 312 in a yellow color indicating current job progress. In this example, the task management unit 134 displays a task 222 or 322, which is currently in progress among tasks of the next job item 212 or 312, in the yellow color in association with the current job progress. However, the tasks and the color listed above are merely examples, and other tasks and colors may be used depending on the situation. If the task 222 or 322 and the remaining tasks of the next job item 212 or 312 are performed simultaneously, the task management unit 134 displays all of these tasks in the yellow color. Accordingly, the person in charge may easily identify which stage of the project is being performed.

In an example, the task management unit 134 (of FIG. 1) compares job performance period information of the task 222 or 322 displayed in the yellow color with current job period information, and checks whether the task 222 or 322 is being performed within a job performance period, e.g., whether the current job period information is less than or equal to the job performance period. For example, as shown in FIG. 2, if the job performance period information of the task 222 is 2009 Oct. 10 and the current job period information is 2009 Oct. 15, the task management unit 134 changes the color of the task 222 from yellow to red. Accordingly, the person in charge may identify that the task 222 is in progress beyond the job performance period.

Referring again to FIG. 1, the controller 130 further includes a result informing unit 137. The result informing unit 137 transmits a processing result guide message to a mail or a mobile terminal of a person in charge of a next stage of the project based on a result of the processing by the task management unit 134 and/or the job item approval unit 135. For example, referring to FIGS. 1 and 2, if the job item approval unit 135 displays the approval item 231 in the blue color, the result informing unit 137 transmits the processing result guide message to the mail or the mobile terminal of the person in charge of the next job item 212, to inform the person in charge that the job item 211 has been completed. Accordingly, in response to the processing result guide message, the person in charge performs and/or initiates the next job item 212 swiftly so that the project may be performed swiftly.

Referring again to FIG. 1, the controller 130 further includes a task material reading unit 138. Based on a user request, the task material reading unit 138 obtains performance result information of a task completed in each job item associated with the project, from a project database (DB) 150, which stores performance result information of tasks completed in each job item associated with projects. That is, if there is relevant material (e.g., performance result information) when a task is completed, the person in charge requests to store the relevant material associated with the task. Based on this request, the task material reading unit 138 stores the relevant material in the project DB 150 as the performance result information of the task.

If the relevant material is stored in the project DB 150, the task material reading unit 138 outputs a list of the performance result information stored in the project DB 150 associated with completed tasks, to the screen through a performance result information guide section 240 or 340, as shown in FIG. 2 or 3, respectively. If the person in charge inputs material request information regarding the completed task with reference to the list of the performance result information, the task material reading unit 138 obtains the performance result information corresponding to the material request information, e.g., regarding the completed task. The task material reading unit 138 outputs the performance result information to the screen. Accordingly, the person in charge may read the performance result information regarding the completed task from among the tasks of the job item of each stage on a real-time basis.

Referring again to FIG. 1, the controller 130 further includes a project progress providing unit 139. The project progress providing unit 139 compares job performance period information of all of the job items stored in the project DB 150 with job completion period information of a completed job item, and provides a progress of the project based on the comparison. As described above, the project DB 150 stores the performance result information of the tasks in each job item of the projects. In addition, the project DB 150 stores the job performance period information of all of the job items of the projects and the tasks associated with the job items. Also, the project DB 150 stores the job completion period information of the completed job item and the tasks associated with the completed job item.

Accordingly, the project progress providing unit 139 compares the job performance period information of a job item in an initial stage of the project with the job completion period information of a latest completed job item with reference to the project DB 150, to predict the progress of the project. The project progress providing unit 139 displays a color of a project title based on a result of the prediction. For example, as shown in FIG. 2, if the job performance period information of the job item 211 in an initial stage of a project “Mobile Audio Codec” is 2009 Oct. 1, and the job completion period information of the latest completed job item 211 is 2009 Sep. 30, the project progress providing unit 139 predicts that a job performance period of a final job item of the project to be completed, will be shortened from 2010 Nov. 30 to 2010 Nov. 29. Accordingly, the project progress providing unit 139 predicts that the project “Mobile Audio Codec” will be completed within the job performance period of the final job item, and displays a project title 250 in the green color based on the prediction.

In another example, as shown in FIG. 3, if the job performance period information of the job item 311 in an initial stage of a project “D53E5EA8967” is 2009 Nov. 28 and the job completion period information of the latest completed job item 311 is 2011 Feb. 8, the project progress providing unit 139 predicts that a job performance period of a final job item of the project to be completed, will be extended as much as a time by which the job item 311 is delayed. Accordingly, the project progress providing unit 139 predicts that the project “D53E5EA8967” will not be performed within the job performance period of the final job item, and displays a project title 350 in the red color based on the prediction. However, the values and the color listed above are merely examples, and other values and colors may be used depending on the situation. In still another example, the project progress providing unit 139 may display the project title 350 in a color indicating a normal state (for example, blue) or in a color indicating an abnormal state (for example, red) based on whether the job performance period of the final job item is extended by an amount greater than a predetermined threshold. The project progress providing unit 139 displays the color of the project title based on the result of the prediction of the progress of the project, so that the person in charge may identify whether the project will be performed within the scheduled job performance period of the final job item based on the color of the project title.

Referring again to FIG. 1, the controller 130 further includes a situation statistic unit 140. The situation statistic unit 140 provides progress information of each job item of the projects and/or job stage information, with reference to the job performance period information and the job completion period information of each job item of the projects stored in the project DB 150. For example, the situation statistic unit 140 compares the job performance period information with the job completion period information, and based on the comparison, displays a current situation of a project in which job items are normally performed in each stage, and a current situation of a project in which job items are abnormally performed in each stage, collectively on a screen using a graph, e.g., displays the progress information. In another example, the situation statistic unit 140 compares the job performance period information and the job completion period information, and based on the comparison, displays a current situation of a job item in each stage collectively on the screen using a graph, e.g., display the job stage information. Accordingly, the user may grasp the progress of the project in each stage and/or the progress of the job item of each project easily and swiftly.

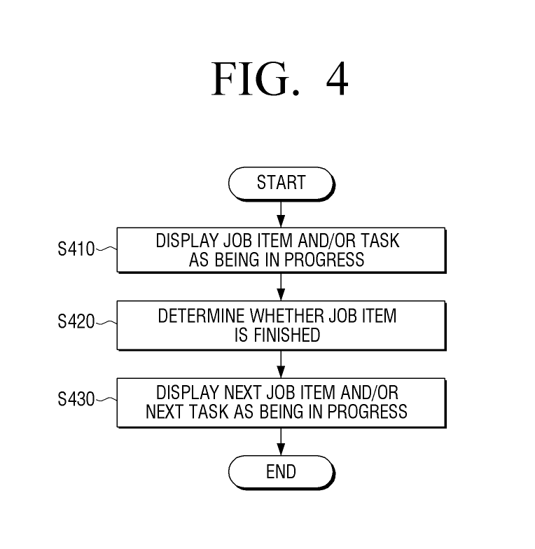

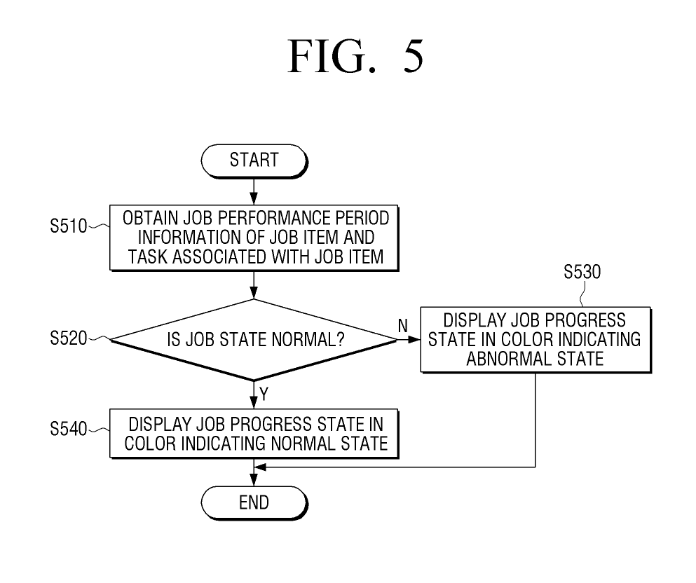

FIG. 4 is a flowchart illustrating an example of a method of managing a new product and technology introduction based on a work process. At step S410, an apparatus configured to manage a new product and technology introduction based on a work process, displays at least one job item, from among job items performed in stages in a project, and/or at least one task associated with the job item, as being in progress. For example, the project may be a semiconductor technology introduction project and/or a semiconductor new product project, and the apparatus collectively manages the semiconductor technology introduction project and the semiconductor new product project. The method of displaying the job item or the task as being in progress may be achieved as shown in FIG. 5.

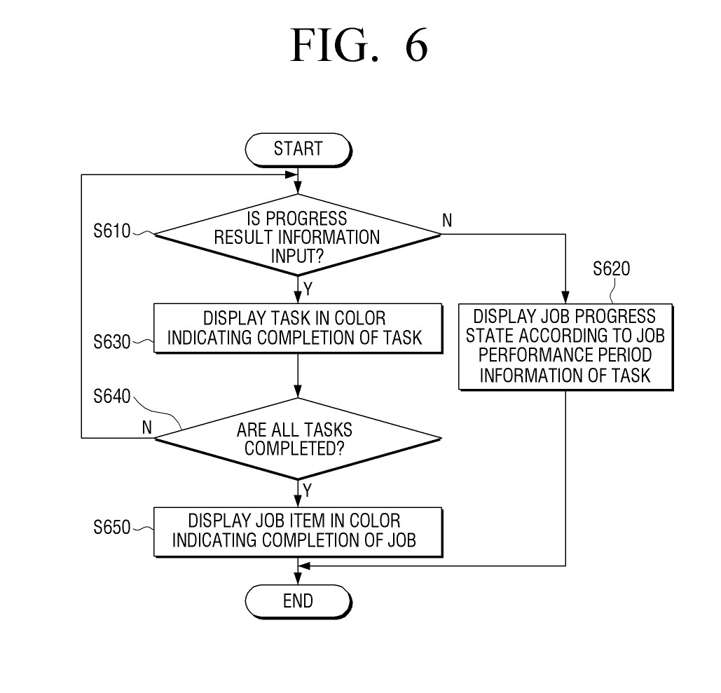

At step S420, the apparatus determines whether the job item is finished based on whether the task is completed. The method of determining whether the job item is finished may be achieved by a method shown in FIG. 6.

If the job item is finished, the apparatus determines whether there is a next job item to be performed in a next stage of the project. If there is no next job item to be performed, the apparatus finishes managing the project. If there is the next job item to be performed, at step S430, the apparatus displays the next job item and/or at least one next task associated with the next job item, as being in progress.

FIG. 5 is a flowchart illustrating a method of displaying a job progress state of a job item in each stage of a project and/or at least one task associated with the job item in an apparatus configured to manage a new product and technology introduction based on a work process. The apparatus generates the job item in each stage to perform the project (e.g., a technology introduction or new product-related project) and the task(s) to be performed in the job item based on generation request information of the job item in each stage that is input by a user. The generation request information includes information on the job item performed in each stage of the project and information on the task(s) of each job item. Also, the generation request information includes job performance period information of the job item in each stage and job performance period information of the task(s) associated with each job item.

At step S510, the apparatus obtains the job performance period information of a job item and a task(s) associated with the job item. At step S520, the apparatus determines whether a job progress state of the job item and the associated task(s), is normal based on the obtained job performance period information. That is, the apparatus determines whether the job item and the associated task(s) being currently performed are achieved within a predetermined period based on the obtained job performance period information.

If the job progress state of the job item displayed as being in progress and the associated task(s) is abnormal, the method continues in step S530. Otherwise, the method continues in step S540. At step S530, the apparatus displays the job item and the associated task(s) in a color indicating an abnormal state, to display the job progress state or to display the job item and the associated task(s) as being in progress. At step S540, the apparatus displays the job item and the associated task(s) in a color indicating a normal state, to display the job progress state or to display the job item and the associated task(s) as being in progress. However, the steps listed above are merely examples, and other steps may be used depending on the situation.

In examples, if the job progress state of the job item and the associated task(s), is normal, the apparatus may retain a current color of the job item and the associated task(s). If the job item is progressing within a job performance period, but the associated task(s) is progressing beyond the job performance period, the apparatus may retain a current color of the job item in a current stage of the project, but may change a color of the associated task(s) to red indicating the abnormal state.

FIG. 6 is a flowchart illustrating a method of determining whether to finish a job item displayed as being in progress in an apparatus configured to manage a new product and technology introduction based on a work process. At step S610, the apparatus determines whether progress result information indicating completion of a a task associated with the job item displayed as being in progress, is input. If the progress result information is not input, the method continues at step S620. Otherwise, the method continues at step S630.

At step S620, the apparatus displays the task in a color indicating a job progress state of the task according to predetermined job performance period information of the task. That is, the apparatus compares the predetermined job performance period of the task with a current job period. If the task is achieved or being performed within the predetermined job performance period, the apparatus retains the task in a color indicating a current (i.e., normal) job progress state of the task. On the other hand, if the task is being performed beyond the predetermined job performance period, the apparatus displays the task in a color indicating an abnormal job progress state of the task.

At step S630, the apparatus displays the task in a color indicating the completion of the task. For example, if the progress result information indicating completion of the task is input, the apparatus may display the task in a blue color indicating the completion of the task.

At step S640, the apparatus determines whether all of tasks of the job item are displayed in the color indicating the completion of the tasks. If all of the tasks are not displayed in the color indicating the completion of the tasks, the method continues in step S650. Otherwise, the method returns to step S610.

At step S650, the apparatus displays the job item in the color indicating completion of the job item and/or the associated tasks. That is, if all of the tasks are displayed as being completed, the apparatus displays the job item associated with the completed tasks in the color indicating the completion of the job item and/or the associated tasks based on an approval request of a person in charge. If the job item is displayed in the color indicating the completion of the job item and/or the associated tasks, the apparatus checks whether there is a job item to be performed in a next stage of the project, as described in FIG. 4.

According to the teachings above, there is provided an apparatus and a method for managing a new product and technology introduction based on a work process, in which a person in charge may easily grasp a job item that has been finished or is progressing. Also, the person in charge may easily grasp a progress state of each job item.

The units described herein may be implemented using hardware components and software components. For example, the hardware components may include microphones, amplifiers, band-pass filters, audio to digital converters, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. For example, the software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments to accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus configured to manage a new product and technology introduction based on a work process, comprising:
a display unit configured to display each stage of a project;
an input unit configured to receive generation request information of a job item in each stage and progress result information indicating completion of the job item in each stage; and
a controller configured to control the display unit to display each stage of the project based on the generation request information and/or the progress result information.

2. The apparatus as claimed in claim 1, wherein the controller comprises:
a job item generation unit configured to generate the job item in each stage based on the generation request information; and
a task generation unit configured to generate a task associated with the job item in each stage based on the generation request information.

3. The apparatus as claimed in claim 2, wherein:
the generation request information comprises job performance period information of the job item and the task in each stage; and
the controller further comprises a job period display unit configured to display the job performance period information based on the generation request information.

4. The apparatus as claimed in claim 2, wherein the controller further comprises:
a task management unit configured to display a color of a current task in a current stage of the project based on the progress result information;
a job item approval unit configured to determine whether to progress to a next job item in a next stage of the project based on the color of the current task, and determine whether to change the color of the current task that has been completed based on the determination of whether to progress to the next job item; and
a job item management unit configured to display colors of a current job item in the current stage and the next job item based on the determinations of the job item approval unit,
wherein the task management unit is further configured to display a color of a next task in the next stage based on the determinations of the job item approval unit.

5. The apparatus as claimed in claim 4, wherein the task management unit is further configured to display the color of the current task based on job performance period information of the current task.

6. The apparatus as claimed in claim 4, wherein the job item management unit is further configured to:
compare job performance period information of the current job item with job completion period information generated if the current job is completed; and
display a portion of the current job item in a color different from that of the current job item.

7. The apparatus as claimed in claim 4, wherein the controller further comprises a result informing unit configured to transmit a processing result guide message to a mail or a mobile terminal of a person in charge of the next stage based on the displaying of the task management unit or the determinations of the job item approval unit.

8. The apparatus as claimed in claim 2, further comprising:
a project DB configured to store performance result information indicating completion of a task in each stage of projects,
wherein the controller further comprises a task material reading unit configured to provide the performance result information from the project DB based on a request of a user.

9. The apparatus as claimed in claim 8, wherein:
the project DB is further configured to store job performance period information of a job item in each stage of the projects, and job completion period information generated if the job item in each stage of the projects is completed; and
the controller further comprises a project progress providing unit configured to compare the job performance period information with the job completion period information, and provide a progress of the project.

10. The apparatus as claimed in claim 9, wherein the controller further comprises a situation statistic unit configured to provide information of situations of the projects or information of a situation of the job item in each stage of the project based on the job performance period information and the job completion period information.

11. The apparatus as claimed in claim 1, wherein the project is a semiconductor technology introduction project and/or a semiconductor new product project.

12. A method of managing a new product and technology introduction based on a work process, comprising:
displaying a current job item among job items performed in a project, and/or a current task associated with the current job item, as being in progress;
determining whether the current job item is finished based on whether the current task is completed; and
displaying a next job item among the job items, and/or a next task associated with the next job item, as being in progress if the current job item is finished.

13. The method as claimed in claim 12, wherein the displaying of the current job item and/or the current task comprises:
receiving job performance period information of the current job item and/or the current task;
determining whether a job state of the current job item is normal based on job performance period information of the current job item; and
displaying the current job item and the current task in a color based on whether the job state is normal.

14. The method of claim 13, wherein the determining of whether the job state is normal comprises determining whether the current job item and the current task are being performed within the job performance period information.

15. The method as claimed in claim 13, wherein the determining of whether the current job item is finished comprises:
determining whether progress result information indicating completion of the current task is input;
displaying the current task in a color indicating the completion of the current task if the progress result information is input; and
determining whether the current task is completed based on whether the current task is in the color indicating the completion of the current task.

16. The method as claimed in claim 15, wherein the determining of whether the current job item is finished further comprises displaying the current job item in a color indicating completion of the current job if the current task is in the color indicating the completion of the current task.

17. The method as claimed in claim 15, wherein the determining of whether the current job item is finished further comprises displaying the current task in a color indicating a job progress state of the current task based on the job performance period information of the current task if the progress result information is not input.

18. The method of as claimed in claim 17, wherein the displaying of the current task in the color indicating the job progress state comprises:
displaying the current task in a color indicating a normal job progress state of the current task if the current task is being performed within the job performance period information; and
displaying the current task in a color indicating an abnormal job progress state of the current task if the current task is being performed beyond the job performance period information.

19. The method as claimed in claim 12, wherein the project is a semiconductor technology introduction project and/or a semiconductor new product project.

20. A computer-readable storage medium storing a program comprising instructions to cause a computer to perform the method of claim 12.
